(19) United States
(12) Patent Application Publication
(10) Pub. No.: US 2003/0089665 A1
(43) Pub. Date: May 15, 2003

(54) Arsenic removal media

(75) Inventor: Thomas J. Shaniuk, Strongsville, OH (US)

Correspondence Address: Engelhard Corporation, 101 Wood Avenue, P.O. Box 770, Iselin, NJ, 08830-0770, US

(73) Assignee: Engelhard Corporation

(21) Appl. No.: 10/002,458

(22) Filed: Nov. 15, 2001

(51) Int. Cl. C02F 1/42

(52) U.S. Cl. 210/668; 210/681

(57) ABSTRACT

A media for removal of arsenic from an aqueous system comprising a mixture of: activated bauxite, aluminum trihydrate and a ferric compound selected from the group consisting of ferric hydroxide, ferric oxyhydroxide, ferric hydroxyoxide and mixtures thereof. The mixture is preferably calcined and is thereafter formed into a powder, granules or extruded particles. Preferably, the mixture prior to calcination also contains a natural or synthetic filler which has the capability of modifing the porosity of the mixture. Removal of arsenic from the aqueous system is readily accomplished by contacting the aqueous system with the media until the arsenic is substantially removed from the aqueous system. If arsenic is present in the aqueous system in the +3 valence state, the aqueous system is preferably oxidized to convert the arsenic to the +5 valence state prior to contact of the aqueous system with the media.

### BACKGROUND OF THE INVENTION

1. Field of the Invention

The invention relates to a novel media for the substantial removal of arsenic from aqueous systems.

2. Description of Related Prior Art

Arsenic, classified by the EPA as a Class A carcinogen, is the 20th most abundant element in the earth's crust. As a result, arsenic contamination of drinking water sources is common, particularly in the western United States.

The removal of arsenic from water by adsorption is generally known in the art. See, for example, J. H. Gulledge and J. T. O'Connor, “Removal of Arsenic (V) from Water by Adsorption on Aluminum and Ferric Hydroxides,” Water Technology/Quality Journal AWWA, August, pages 548-552 (1973) and M. A. Anderson, J. F. Ferguson and J. Gavis, “Arsenate Adsorption on Amorphous Aluminum Hydroxide,” Journal of Colloid and Interface Science, Vol. 54, No. 3, March (1976).

Also, D. Clifford and C. Lin, “Arsenic (II) and Arsenic (V) Removal from Drinking Water in San Ysidro, N. Mex.,” U.S. EPA Project Summary—EPA/600/S2-91-011 June (1991), report results of using activated alumina for the removal of arsenic from drinking water.

S. K. Gupta and K. Y. Chen, “Arsenic Removal by Adsorption” Journal WPCF, pages 493-506, March 1978, report using activated alumina, activated bauxite and activated carbon as adsorbents for arsenic in water.

U.S. Pat. No. 4,935,146 describes a method for reducing the amount of a first contaminant and second contaminant in a solution to environmentally safe levels, said solution having a substantially greater amount of the first contaminate than the second contaminant. The method comprises: contacting the solution with an activated or calcined product of a compound having the formula A6B2(OH)16C.4H20, wherein A is a divalent metal cation, B is a trivalent metal cation and C is a mono- to tetravalent anion. The method further comprises separating the solution from the contacted product.

My prior patent, U.S. Pat. No. 6,030,537, describes a process for the substantial removal of arsenic from aqueous systems containing competing ions using an absorbent material formed by mixing powders comprising a combination of activated bauxite and aluminum trihydrate with sufficient water to form an absorbent material which is subsequently dried and calcined. The present invention provides a significant improvement over that described in my '537 patent in that the arsenic adsorption capacity of the media of the present invention is significantly higher than that of the absorbent material disclosed in my '537 patent.

The EPA's maximum concentration limit for arsenic in drinking water of 50 micrograms per liter (50 parts per billion) will be reduced to below 10 micrograms per liter, as already has been done (1995) by the World Health Organization.

In view of the anticipated stringent EPA regulations for arsenic, there is a need for adsorbent materials which are effective at lowering arsenic levels in drinking water to lower than ten parts per billion and which have arsenic absorptive capacities suitable for commercial applications.

### SUMMARY OF THE INVENTION

The invention relates to an arsenic removal media, a method for preparing such media and a method for removing arsenic from aqueous systems using such media.

In one embodiment, the media is prepared by mixing powders comprising a combination of activated bauxite, aluminum trihydrate and a ferric compound selected from the group consisting of ferric hydroxide, ferric oxyhydroxide, ferric hydroxyoxide and mixtures thereof with a sufficient amount of water to provide a formed absorbent material, drying the resultant material and calcining the dried material.

### BRIEF DESCRIPTION OF THE DRAWINGS

FIG. 1 is a graph which depicts Arsenic⁺⁵ pH-Absorption Edge. The percent of arsenic⁺⁵ removed is shown at various final pH levels of water.

FIG. 2 is a graph which depicts Arsenate (As⁺⁵) Freundlich Isotherm at a pH of 6.5 in water containing competing ions. The graph shows the absorbent capacity, (x/m) in milligrams of As⁺⁵ per gram of sorbent versus the Equilibrium Constant, i.e., Cf, expressed in milligrams per liter.

### DETAILED DESCRIPTION OF THE PREFERRED EMBODIMENT

The method of this invention is for removing arsenic in aqueous systems containing arsenic and possibly other competing ions. The aqueous systems to which the method of the instant invention is typically applied are industrial, municipal or residential water streams. A preferred use for this method is in the treatment of drinking water. US drinking water supplies typically contain less than 5 ppb (micrograms/liter). However, elevated arsenic concentrations are common in ground waters of the western United States as well as in parts of India, Thailand, and other regions of the world. Higher concentrations, up to several hundred micrograms per liter, also occur in surface waters influenced by hydrothermal inputs.

The problem is most acute in desert regions where well water (ground water) is the source. Arsenic removal from aqueous streams becomes complicated when there is also a presence of other contaminants, i.e., competing ions. Such competing ions include alkaline earth metals, particularly calcium or magnesium sulfates, phosphates and halide ions such as chlorides or fluorides. Commonly, these competing ions are present in amounts of from about 50 ppm up to about 800 ppm, more typically from about 100 up to about 300 ppm. The presence of these competing ions makes arsenic removal from aqueous system much more difficult. Primarily, the other ions present will compete for available adsorption sites on the adsorbent materials and lower the arsenic removal efficiency.

In drinking water treatment, the most common competing ions are sulphate, phosphate, chloride and fluoride ions.

The arsenic removal media of the present invention comprises a mixture of:

(a) activated bauxite;

(b) aluminum trihydrate; and

(c) a ferric compound selected from the group consisting of ferric hydroxide, ferric oxyhydroxide, ferric hydroxyoxide and mixtures thereof.

Bauxite, which is suitable for use in the instant invention, is composed principally of hydrated aluminum oxide (Al₂O₃.xH₂O) and contains small quantities of silica, titania, kaolinate and hematite (Fe₂O₃). Bauxite is principally Al₂O₃.2H₂O. Activated bauxites are well known to those skilled in the art. Activation of Bauxite is usually accomplished by heat treatment, typically at about 350° C. or more, and up to about 700° C., preferably from about 350° C. up to about 500° C. The media is exposed to high temperatures for approximately 30 to 60 minutes. The media can undergo heat treatment for longer periods of time without detrimental effects. It is desirable that the activated bauxite suitable for the instant invention contain at least 5% weight iron as Fe₂O₃ and 2% by weight TiO₂. Preferably, the activated bauxite has an iron content of from about 5% up to about 15% by weight as Fe₂O₃ and a titanium content of from about 2% up to about 5% by weight as TiO₂. The properties of a preferred activated bauxite are:

| | |
|---|---|
| Volatile Material, % | 9 |
| (Wt. Loss @ 980 C) | |
| Mesh Grades | minus 60 |
| Chemical Composition % | Al₂O₃: 73-78 |
| Typical | Fe₂O3: 8-16 |
| (Volatile Free Basis) | TiO₂: 4 |
| | SiO₂: 6-9 |
| | Insol: 1 |
| Bulk Weight Typical | 57 lbs./cu. ft. |

The aluminum trihydrate useful for this invention is also commonly known as alumina trihydrate, aluminum hydroxide, alumina hydrate, hydrated alumina hydrated aluminum oxide, gibbsite, pseudoboehmite and is represented by the formulas Al₂O₃.3H₂O, Al(OH)₃, or AlOOH which may be as a crystalline material or as a gelatinous precipitate.

Preferably, the aluminum trihydrate should be a dry crystalline powder with at least 70% by weight solids on a moisture-free basis. The remainder being free and bound water. As used herein, moisture-free basis means solids weight after heat treatment at 500° C. for 1 hour. Average particle size of the powder being from about 20 microns up to about 75 microns. The surface area of the powder is typically 300 m²/g.

The ferric compound is available commercially in various forms: ferric hydroxide is the most commonly commercially available form and has the formula Fe(OH)3. Another useful commercially available ferric compound is ferric oxyhydroxide which has the formula FeO(OH). A third useful commercially available ferric compound is ferric hydroxyoxide which has the formula Fe(OH)O. For the purposes of this invention, mixures of the foregoing ferric compounds are also useful.

Preferably, one or more natural or synthetic fillers are also present in the mixture. Such fillers should be those which have the capability of modifing, i.e., increasing, the porosity of the final media. Suitable examples of such fillers are flours derived from nut shells (e.g., walnut shells, pecan shells, cashew nut shells, etc.) fruit pits (e.g., peach pits, apricot pits, etc.), corn cobs, rice hulls, wood, polyolefins, cellulose and starch. Mixtures of one or more of the foregoing fillers are also useful for the purposes of this invention. If one or more of such fillers are employed, it should be recognized that they would have burned off in the course of calcination of the mixture (the calcination step is discussed below). Nevertheless, such fillers would have served their purpose in increasing the porosity of the mixture and it is of no moment that they are not present when the aqueous system containing arsenic is contacted with the media.

The activated bauxite is preferably present in the mixture in an amount of about 25 to about 75 wt. %, based on the weight of the mixture on a moisture-free basis.

The aluminum trihydrate is preferably present in the mixture in an amount of about 25 to about 80 wt. %, based on the weight of the mixture on a moisture-free basis.

The ferric compound is preferably present in the mixture in an amount of about 2 to about 25 wt. %, based on the weight of the mixture on a moisture-free basis.

If employed, the natural or synthetic filler is preferably present in the mixture in an amount of about 2 to about 20 wt. %, based on the weight of the mixture on a moisture-free basis.

The arsenic removal media may be utilized for the substantial removal of arsenic from aqueous systems in the form of a powder, granules or extruded particles. If utilized as a powder, the arsenic removal media will preferably have an average particle size of about 10 to about 75 microns. If utilized in the form of granules, the arsenic removal media will preferably have an average particle size of about 4 to about 400 mesh. If utilized in the form of extruded particles, the arsenic removal media will preferably have an average particle size of about 1/32 to about ⅛ inch.

The method for preparing the arsenic removal media of the present invention is relatively straightforward and generally involves the following steps:

(a) mixing powders comprising a combination of (i) activated bauxite, (ii) aluminum trihydrate and (iii) a ferric compound selected from the group consisting of ferric hydroxide, ferric oxyhydroxide, ferric hydroxyoxide and mixtures thereof with a sufficient amount of water to provide a formed absorbent material;

(b) drying the absorbent material resulting from step (a); and

(c) calcining the dried absorbent material resulting from step (b).

The absorbent material formed in step (a) will generally be present in the form of granules typically having an average particle size range as indicated above. If desired, the formed granules may be ground into a powder having the preferable average particle size as indicated above. Alternatively, the absorbent material from step (a) may be extruded such that the extruded particles will preferably have the average particle size range as indicated above.

The drying of step (b) is typically conducted at a temperature of about 50 to about 150° C. The calcination of step (c) is typically conducted at a temperature of about 300 to about 750° C. for a period of about 0.5 to about 2 hours.

The arsenic removal media of the present invention is typically packed into a fixed-bed adsorbent column or container. The arsenic-containing aqueous stream is pumped into the adsorbent bed system in either an up-flow or down-flow fashion. Treated water with significantly reduced levels of arsenic will flow out of the system.

Arsenic concentrations in the effluent should be less than 50 ppb (micrograms/liter) to be considered substantially removed. If, however, it is desired to meet the proposed EPA standard, arsenic concentrations in the effluent should be less than 10 ppb. As may be seen from the data set forth below, the arsenic removal media of the present invention has the capability of reducing arsenic concentration in aqueous systems even to the proposed EPA levels, while at the same time maintaining commercially attractive absorption capacities.

If the aqueous system to be treated contains a significant concentration of arsenic in the +3 valence state, it is preferred that the aqueous system be contacted with an oxidizing agent so as to oxidize the arsenic to the +5 valence state, prior to or concurrent with the contact of the aqueous system with the arsenic removal media of the present invention. The oxidation reaction is typically conducted at ambient temperatures with the aid of well-known oxidizing agents such as ambient air, hydrogen peroxide, oxygen, ozone, chlorine, a chloroxide, manganese dioxide, an alkali metal permanganate, a chromate, a dichromate and mixtures thereof.

If desired, the media of the invention can be used in a powder form for arsenic removal. The adsorbent powder can be combined with carbon, alumina, polymer binder, or other powders and formed into a multi-component block cartridge filter. The adsorbent powder can also be used as is in water treatment or clarification systems and in pre-coat filter/adsorption systems.

Nonlimiting examples of the present invention are set forth below. Unless otherwise indicated to the contrary, all parts and percentages are on a weight basis.

### EXAMPLE 1

525 parts of activated bauxite powder (Porocel® RI powder, minus 325 mesh grade, (8% Fe₂O₃ and 4% TiO₂) were mixed with 650 parts of aluminum trihydrate (Laroche Versal® 250), 62 parts of ferric (III) hydroxide powder (Noah Technologies, 99% pure, minus 325 mesh) and 50 parts of walnut shell flour (Composition Materials Co. Comp. Bond, minus 325 mesh) for three minutes in an Eirich Mixer. Thereafter, 1025 parts of deionized water were added to the powders while mixing to form small granules. The granules were dried at 110° C. for 16 hours, screened to 20×50 mesh, and then calcined for one hour at 350° C.

### EXAMPLE 2

250 parts of activated bauxite powder (Porocel® RI powder, minus 325 mesh grade, (8% Fe₂O₃ and 4% TiO₂) were mixed with 306 parts of aluminum trihydrate (Laroche Versal® 250), 62 parts of ferric (III) hydroxide powder (Noah Technologies, 99% pure, minus 325 mesh) and 50 parts of walnut shell flour (Composition Materials Co. Comp. Bond, minus 325 mesh) for three minutes in an Eirich Mixer. Thereafter, 500 parts of deionized water were added to the powders while mixing to form small granules. The mix was then extruded through a 1/16″ die plate. The extrudates were then dried at 110° C. for 16 hours, and then calcined for one hour at 300-500° C.

### EXAMPLE 3

525 parts of activated bauxite powder (Porocele® RI powder, minus 325 mesh grade, (8% Fe₂O₃ and 4% TiO₂) were mixed with 650 parts of aluminum trihydrate (Laroche Versal® 250) and 62 parts of ferric (III) hydroxide powder (Noah Technologies, 99% pure, minus 325 mesh) for three minutes in an Eirich Mixer. Thereafter, 1000 parts of deionized water were added to the powders while mixing to form small granules. The granules were dried at 110° C. for 16 hours, screened to 20×50 mesh, and then further heat treated in a drier at 150-200° C.

### EXAMPLE 4

450 parts of activated bauxite powder (Porcel® RI powder, minus 325 mesh grade, (8% Fe₂O₃ and 4% Ti0₂) were mixed with 540 parts of aluminum trihydrate (Laroche Versal® 250), 44 parts of ferric (III) hydroxide powder (Noah Technologies, 99% pure, minus 325 mesh) and 42 parts of walnut shell flour (Composition Materials Co. Comp. Bond, minus 325 mesh) together with 1625 parts of deionized water in a stirred tank. The mixture was then pumped into a Bowen No.1 Spray Drier equipped with a two-fluid spray nozzle. An inlet temperature of 525° C. and an outlet temperature of 130-140° C. were maintained. The dried powder was then calcined at 350° C. for two hours.

### Evaluation Procedure

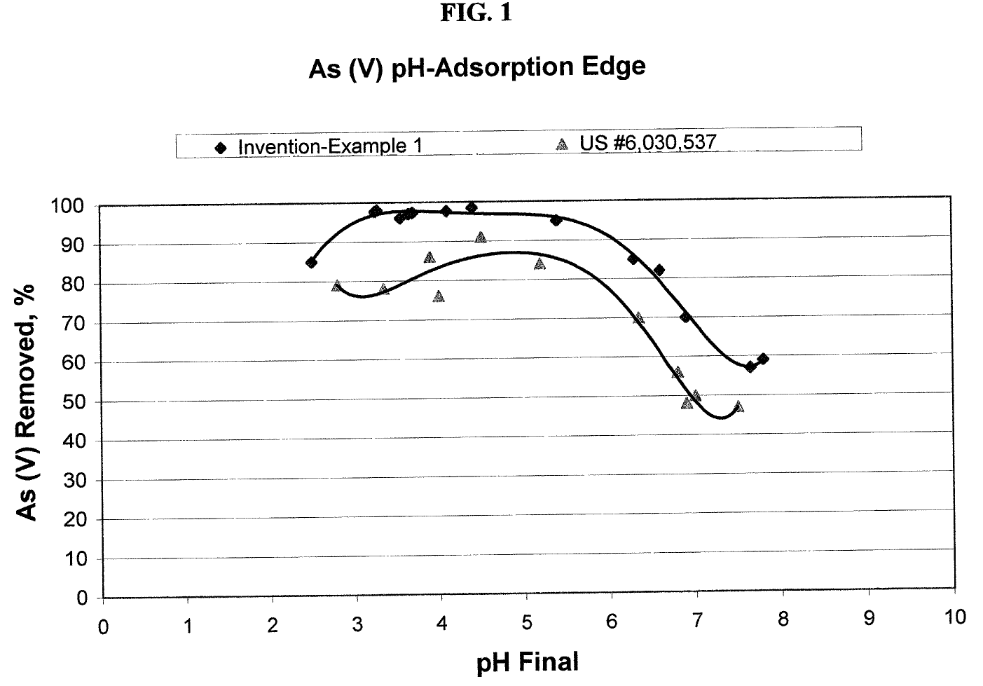

The pH absorption edge data reflected in FIG. 1 were determined by batch adsorption experiments. First, a 1-liter solution of 10 ppm As (V) is prepared by adding the requisite amount of sodium arsenate to deionized water. Thereafter, the absorbent material to be tested is, ground and sieved through a 100-mesh screen. A specific amount of the −100 mesh absorbent powder, equivalent to 0.65 g/l is mixed into the arsenate solution. The liter mixture is separated into twenty (20) 50 ml aliquot samples and placed in fresh plastic bottles. The pH of each aliquot sample was then adjusted with 0.1N NaOH or 0.1-1.0N HNO₃ such that the initial pH of the 20 samples will range from 2.0 to 11.0. The bottles are sealed and placed into a reciprocating shaker for 24 hours. After shaking, the absorbent material is filtered off and the filtrate is placed in fresh plastic bottles. The filtrate is preserved by the addition of a few drops of 1% HNO₃ to prevent arsenic loss. The final residual concentration of arsenic is measured using a Perkin-Elmer 5100ZL Graphite Furnace Atomic Adsorption Spectrometer.

Freundlich Isotherm Data is determined by carrying out pH Adsorption Edge experiments at absorption loadings of 0.1, 0.25, 0.45 and 0.56 g/l and plotting the data according to the Freundlich Equation:

x/m=(Cᵢ−C_{f})/m[mg/]

where

Cᵢ=initial arsenic concentration [mg/l]

C_{f}=final residual arsenic concentration [mg/l]

m=adsorbent loading [g/l]

The arsenic solution is prepared by adding the requisite amount of sodium arsenate corresponding to 10 ppm As(V) to deionized water containing several competing ions of Mg, Ca, SO₄, SiO₂, NO₃, F and PO₄ at a total concentration of ˜125 ppm.

### Evaluation Results

The absorbent media of Example 1 of the present invention and that of U.S. Pat. No. 6,030,537 Example 1) were evaluated in respect to As(V) pH-Adsorption Edge in which the percentage of As(V) removed was determined at several different final pH values. The results of such evaluations are shown graphically in FIG. 1.

As may be seen from FIG. 1, at a pH of ˜3, the percentage of As(V) removed by each absorbent media was approximately the same, i.e., 80-90%. However, as the pH was increased to a value of ˜6, the percentage of As(V) dropped off sharply. At a pH of ˜6, the absorbent media of Example 1 of the invention resulted in ˜90% of the As(V) being removed, while only ˜70% of the As(V) was removed with the absorbent media of U.S. Pat. No. 6,030,537. At a pH of ˜6.5, the absorbent media of Example 1 of the invention resulted in ˜85% of the As(V) being removed, while only ˜60% of the As(V) was removed with the absorbent media of U.S. Pat. No. 6,030,537. At a pH of ˜7, the absorbent media of Example 1 of the invention resulted in ˜70% of the As(V) being removed, while only ˜50% of the As(V) was removed with the absorbent media of U.S. Pat. No. 6,030,537.

From the results shown in FIG. 1, it is clear that in the desired pH range of 6-7, the arsenic removal media of the present invention possesses significantly higher absorptive capacity than the absorption media of U.S. Pat. No. 6,030,537.

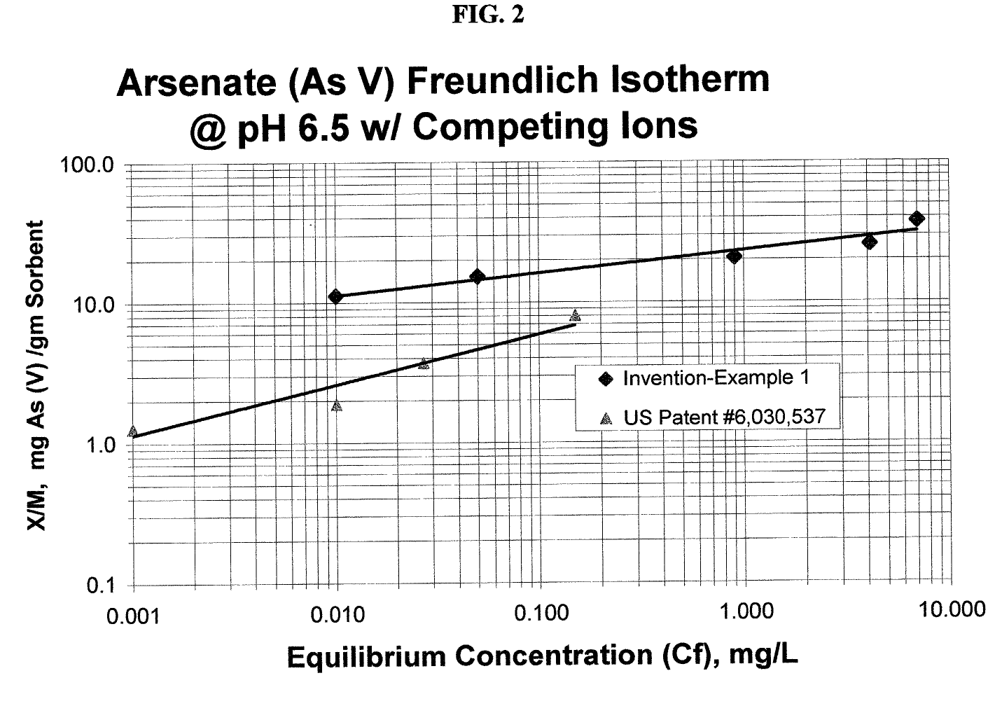

As may be seen from the data graphically set forth in FIG. 2, at the desirable pH of 6.5 in the presence of competing ions, at several final equilibrium concentrations, the value of mg As(V)/g of the sorbent is approximately ten times greater for the arsenic removal media of Example 1 of the present invention as compared to the absorbent media of U.S. Pat. No. 6, 030,537.

What is claimed is:

1. An arsenic removal media comprising a mixture of:
(a) activated bauxite;
(b) aluminum trihydrate; and
(c) a ferric compound selected from the group consisting of ferric hydroxide, ferric oxyhydroxide, ferric hydroxyoxide and mixtures thereof.

2. The media of claim 1 wherein the activated bauxite is present in the mixture in an amount of about 25 to about 75 wt. %, based on the weight of the mixture on a moisture-free basis.

3. The media of claim 1 wherein the aluminum trihydrate is present in the mixture in an amount of about 25 to about 80 wt. %, based on the weight of the mixture on a moisture-free basis.

4. The media of claim 1 wherein the ferric compound is present in the mixture in an amount of about 2 to about 25 wt. %, based on the weight of the mixture on a moisture-free basis.

5. The media of claim 1 further comprising a natural or synthetic filler which has the capability of modifying the porosity of the mixture.

6. The media of claim 5 wherein the filler comprises a flour derived from nut shells, fruit pits, corn cobs, rice hulls, wood, polyolefins, cellulose and/or starch.

7. The media of claim 5 wherein the filler is present in the mixture in an amount of about 2 to about 20 wt. %, based on the weight of the mixture on a moisture-free basis.

8. The media of claim 1 wherein the mixture is subjected to calcination at a temperature of about 300 to about 750° C. for a period of about 0.5 to about 2 hours.

9. The media of claim 8 wherein the mixture is present in the form of a powder having an average particle size of about 10 to about 75 microns.

10. The media of claim 8 wherein the mixture is present in the form of granules having an average particle size of about 4 to about 400 mesh.

11. The media of claim 8 wherein the mixture is present in the form of extruded particles having an average diameter of about 1/32 to about ⅛ inch.

12. A method for preparing an arsenic removal media which comprises the steps of.
(a) mixing powders comprising a combination of (i) activated bauxite, (ii) aluminum trihydrate and (iii) a ferric compound selected from the group consisting of ferric hydroxide, ferric oxyhydroxide, ferric hydroxyoxide and mixtures thereof with a sufficient amount of water to provide a formed absorbent material;
(b) drying the absorbent material resulting from step (a); and
(c) calcining the dried absorbent material resulting from step (b).

13. The method of claim 12 wherein the activated bauxite is present in the combination in an amount of about 25 to about 75 wt %, based on the weight of the combination on a moisture-free basis.

14. The method of claim 12 wherein the aluminum trihydrate is present in the combination in an amount of about 25 to about 80 wt. %, based on the weight of the combination on a moisture-free basis.

15. The method of claim 12 wherein the ferric compound is present in the combination in an amount of about 2 to about 25 wt. %, based on the weight of the combination on a moisture-free basis.

16. The method of claim 12 further comprising incorporating into the combination a natural or synthetic filler which has the capability of modifing the porosity of the mixture.

17. The method of claim 16 wherein the filler comprises a flour derived from nut shells, fruit pits, corn cobs, rice hulls, wood, polyolefins, cellulose and/or starch.

18. The method of claim 16 wherein the filler is present in the combination in an amount of about 2 to about 20 wt. %, based on the weight of the combination on a moisture-free basis.

19. The method of claim 12 wherein the drying of step (b) takes place at a temperature of about 50 to about 150° C.

20. The method of claim 12 wherein the calcination takes place at a temperature of about 300 to about 750° C. for a period of about 0.5 to about 2 hours.

21. The method of claim 20 wherein the absorbent material is formed into a powder having an average particle size of about 10 to about 75 microns.

22. The method of claim 20 wherein the absorbent material is formed into granules having an average particle size of about 4 to about 400 mesh.

23. The method of claim 20 wherein the absorbent material is extruded so as to provide extruded particles having an average diameter of about 1/32 to about ⅛ inch.

24. A method for removing arsenic from an aqueous system which comprises contacting the aqueous system an arsenic removal media until the arsenic is substantially removed from the aqueous system, said media comprising a mixture of:
(a) activated bauxite;
(b) aluminum trihydrate; and
(c) a ferric compound selected from the group consisting of ferric hydroxide, ferric oxyhydroxide, ferric hydroxyoxide and mixtures thereof.

25. The method of claim 24 further comprising subjecting the aqueous system to oxidation to the extent necessary to oxidize any arsenic present in the +3 valence state to arsenic in the +5 valence state prior to contacting the aqueous system with the arsenic removal media.

26. The method of claim 25 wherein the oxidation is carried out by contacting the aqueous system with an oxidizing agent selected from the group consisting of ambient air, hydrogen peroxide, oxygen, ozone, chlorine, a chloroxide, manganese dioxide, an alkali metal permanganate, a chromate, a dichromate and mixtures thereof.

27. The method of claim 24 wherein the activated bauxite is present in the mixture in an amount of about 25 to about 75 wt. %, based on the weight of the mixture on a moisture-free basis.

28. The method of claim 24 wherein the aluminum trihydrate is present in the mixture in an amount of about 25 to about 80 wt. %, based on the weight of the mixture on a moisture-free basis.

29. The method of claim 24 wherein the ferric compound is present in the mixture in an amount of about 2 to about 25 wt. %, based on the weight of the mixture on a moisture-free basis.

30. The method of claim 24 wherein the mixture further comprises a natural or synthetic filler which has the capability of modifying the porosity of the mixture.

31. The method of claim 30 wherein the filler comprises a flour derived from nut shells, fruit pits, corn cobs, rice hulls, wood, polyolefins, cellulose and/or starch.

32. The method of claim 30 wherein the filler is present in the mixture in an amount of about 2 to about 20 wt. %, based on the weight of the mixture on a moisture-free basis.

33. The method of claim 24 wherein the mixture is subjected to calcination at a temperature of about 300 to about 750° C. for a period of about 0.5 to about 2 hours.

34. The method of claim 24 wherein the mixture is present in the form of a powder having an average particle size of about 10 to about 75 microns.

35. The method of claim 24 wherein the mixture is present in the form of granules having an average particle size of about 4 to about 400 mesh.

36. The method of claim 24 wherein the mixture is present in the form of extruded particles having an average diameter of about 1/32 to about ⅛ inch.
